(19) United States
(12) Patent Application Publication
(10) Pub. No.: US 2026/0296363 A1
(43) Pub. Date: Oct. 1, 2026

(54) ROTARY TENSIONER FOR A SEATBELT

(71) Applicant: Autoliv Development AB, Vargarda (SE)

(72) Inventors: Linus LARSSON, Alingsås (SE); Karsten SCHUBEL, Neritz (DE); Haibo WU, Shanghai (CN); Juri KRAUS, Hamburg (DE)

(21) Appl. No.: 19/489,429

(22) PCT Filed: May 30, 2024
(86) PCT No.: PCT/EP2024/064930

§ 371 Date: Dec. 2, 2025

(30) Foreign Application Priority Data
Jul. 20, 2023 (DE) 10 2023 119 213.2

(51) Int. Cl. B60R 22/34

(52) U.S. Cl. CPC B60R 22/3408

(57) ABSTRACT

The invention relates to a rotary tensioner for a seatbelt, comprising a drive device in the form of a mass body chain (3) that is guided in a tube (5) to which compressed gas is supplied, said mass body chain consisting of a plurality of identical individual masses (4), in order to drive a belt reel (10) in the winding direction of the seatbelt and comprising a drive wheel (1) which is rotationally fixed to the belt reel (10) and comprises a plurality of recesses (2) that are arranged on the radial outer face in a uniform manner and are congruently shaped with respect to at least one sub-portion of the outer shape of the individual masses (4), said drive wheel being rotatable about a rotational axis (D) when the drive device is activated, wherein the recesses (2) are dimensioned such that a corresponding individual mass (4) of the mass body chain (3) can be received in each of the recesses (2), wherein a shaped element (6) is arranged on the mass body chain (3) end facing the drive wheel (1), wherein the shaped element (6) has a flat support surface (14), by means of which the shaped element (6) rests against the first individual mass (4), on the shaped element face facing the first individual mass (4) of the mass body chain (3) at least in the region of the second sub-mass (9).

The present invention relates to a rotary tensioner for a seatbelt having the features of the preamble of claim 1.

The basic design of such a rotary tensioner is known from EP 0 755 340B1 . In this rotary tensioner, a mass body chain made up of spherical individual masses is shot onto a drive wheel by the activation of a pyrotechnic propellant, which drive wheel has recesses that are congruent with the shape of the individual masses. The individual masses thus engage with the recesses and drive the drive wheel to a rotary drive movement. The drive wheel can be connected for conjoint rotation permanently or via a coupling to a belt shaft of a belt winder, onto which a seatbelt can in turn be wound. The rotary drive movement of the drive wheel is then transferred either via the fixed connection or via the coupling into a rotary movement of the belt shaft in the winding direction, whereby the seatbelt is wound up and tensioned on the belt shaft. It would also be conceivable to transfer the drive movement of the drive wheel to a belt buckle or an end fitting via suitable power transmission means. The individual masses of the mass chain are guided in a tube, which is closed at the end by the pyrotechnic propellant, which, upon activation, suddenly generates a very large gas flow that is introduced into a pressure chamber between the propellant and the first individual mass or piston and drives the mass body chain.

One problem to be solved with such a rotary tensioner is that the individual masses must be brought into a form-fitting engagement with the recesses to ensure an undisturbed operation of the drive movement.

To solve this problem, WO 01/00 460 A1 already proposes that a shaped element be provided between the first individual mass facing the drive wheel, which has a finder portion in the form of a first sub-mass and a second sub-mass connected to the first sub-mass via a connecting rib for the synchronous steering of the individual masses into the recesses.

Due to the only partially formed contour of the first sub-mass of the shaped element, which is referred to here as the finder portion, it is made possible for the shaped element with the finder portion to engage in one of the recesses independently of the position of the drive wheel. During the further drive movement, the shaped element, through the engagement of the finder portion, may cause a position correction of the drive wheel by a rotation through a certain angle until it reaches a position in which the shaped element enters the subsequent recess synchronously with the second sub-mass. Since the individual masses are in a defined orientation against the second sub-mass of the shaped element, the individual masses are introduced into the subsequent recesses of the drive wheel during the following movement of the mass body chain and the drive wheel, thereby driving the drive wheel synchronously.

One problem with such a rotary tensioner is that the shaped element, in a point-like arrangement, rests against the first individual mass of the mass body chain and can therefore tilt relative to it, causing the shaped element with the finder portion to pivot relative to the inner wall of the tube and, in extreme cases, to wedge itself between the drive wheel and the tube. This wedging of the shaped element creates an additional resistance force which must be overcome by the tensioner drive, thus reducing the tensioning performance. In extreme cases, the wedging of the shaped element can also lead to a blockage of the tensioning movement or to mechanical damage to the tube or the drive wheel, which at least adversely affects the subsequent tensioning drive movement.

Against this background, the invention is based on the object of improving a rotary tensioner of the type in question to such an extent that the probability of the shaped element tilting and thus of a disturbance of the tensioning movement is reduced.

In order to achieve the object, a rotary tensioner having the features of claim 1 is proposed. Further preferred developments can be taken from the dependent claims, the figures and the associated description.

According to the basic concept, claim 1 proposes that the shaped element, at least in the region of the second sub-mass, has a support surface formed by a flattening on its side facing the first individual mass of the mass body chain, with which support surface the shaped element rests against the first individual mass. Due to the flattened support surface, the first individual mass rests on a flattened contact surface instead of a curved contact surface on the shaped element, thereby reducing the acting tilting moments in the event of a lateral deflection of the shaped element relative to the first individual mass or vice versa. This counteracts the tendency of the shaped element to tilt relative to the first individual mass, the tube, and the drive wheel.

It is further proposed that the support surface has a larger extension starting from the center of the shaped element in the direction of the side of the tube facing away from the drive wheel than towards the side of the tube facing the drive wheel. This makes it possible to counteract deliberately the tendency of the shaped element to tilt with the second sub-mass towards the drive wheel, since the first individual mass rests against the flat support surface for a longer portion in the event of such a deflection than in the case of the opposite deflection. The correspondingly lower support of the shaped element when tilting in the other direction is acceptable insofar as the deflection in this direction is limited by the side of the pipe wall facing away from the drive wheel.

It is further proposed that the support surface is formed by an elongate surface which has a constant width in relation to the longer center axis at least in a central portion in the direction of the width of the drive wheel parallel to the rotational axis of the drive wheel and is arranged symmetrically to a first center axis of the shaped element. The pressure force exerted on the shaped element by the first individual mass is converted into a circumferential force exerted on the drive wheel, wherein the pressure force is redirected. This deflection and the contact with the drive wheel is the cause of the possible tilting and jamming of the shaped element. The direction of the force redirection also results in a preferred direction of tilting, which is taken into account by the elongate shape with the longer extension of the support surface on one side. In the direction parallel to the rotational axis of the drive wheel, the pressing forces act symmetrically, and there is no preferred direction of tilting of the shaped element, so that the first individual mass has no preferred direction of deflection relative to the shaped element. For this reason, the support surface in this direction is designed with a constant width and is arranged symmetrically to a first center axis of the shaped element. This results in a directionally neutral support of the shaped element on the first individual mass with respect to this direction.

It is further proposed that the support surface has a straight orientation in a plane perpendicular to the rotational axis of the drive wheel. Due to the straight orientation, the support surface forms a straight support surface when the shaped element tilts laterally, thus more effectively counteracting the tendency of the shaped element to tilt. In this process, the shaped element rolls with its straight support surface on the surface of the first individual mass at the second sub-mass, wherein the possible rolling angle of the shaped element is reduced by the straight design of the support surface compared to a previously used curved support surface.

It is further proposed that the support surface has a curvature, which shapes the support surface into a groove, in an extension oriented in parallel with the rotational axis of the drive wheel. The proposed curved shaping of the support surface in the extension parallel to the rotational axis of the drive wheel improves the support of the shaped element in the event of tilting, even in this direction, by the first individual mass by reducing the possible rolling angle of the shaped element relative to the first individual mass. The curvature of the support surface is directed opposite to the outer curvature of the shaped element in the region of the second sub-mass, so that the support surface forms a groove on the second individual mass.

The invention is explained below using preferred embodiments with reference to the accompanying figures. In the figures:

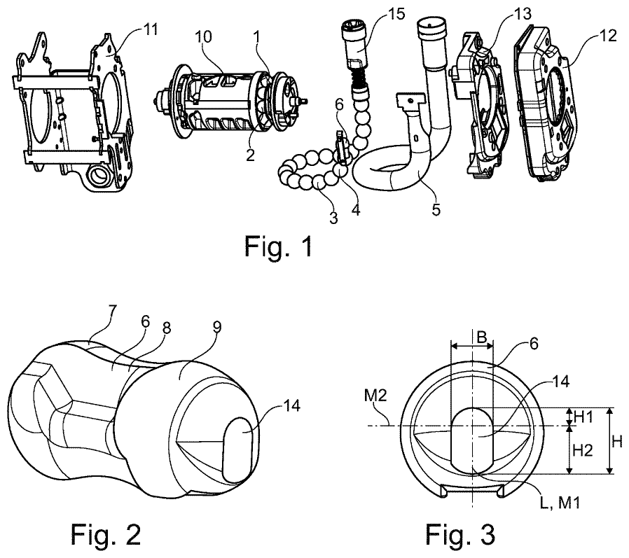

FIG. 1 shows a rotary tensioner with the individual parts before assembly;

FIG. 2 shows a shaped element as an individual part in oblique view;

FIG. 3 shows the shaped element in a view of the second sub-mass;

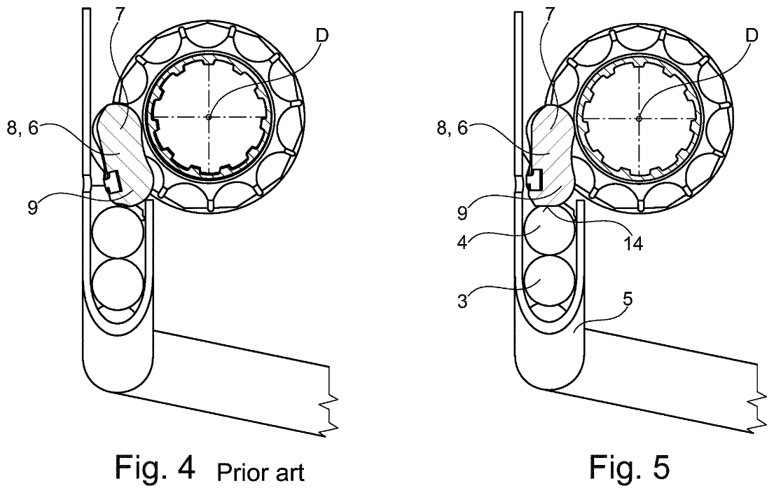

FIG. 4 shows a section through a rotary tensioner with a drive wheel and a shaped element engaging in the drive wheel according to the prior art;

FIG. 5 shows a section through a rotary tensioner according to the invention with a drive wheel and a shaped element engaging in the drive wheel;

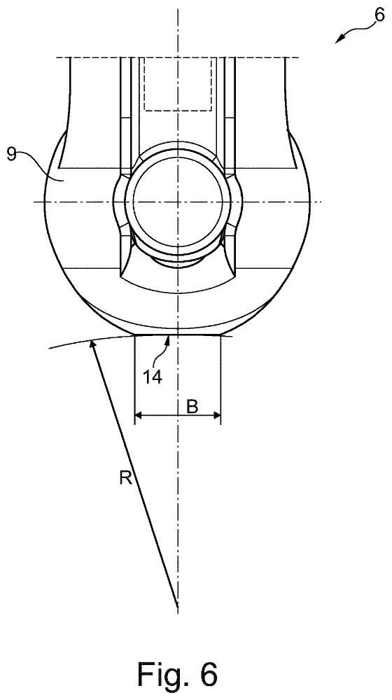

FIG. 6 shows the shaped element in a side view of the second sub-mass.

FIG. 1 shows a rotary tensioner with a drive wheel 1, a tube 5, a drive device in the form of a mass body chain 3 guided in the tube 5 consisting of a plurality of individual masses 4 and a shaped element 6 located on the end face of the mass body chain 3, on the first individual mass 4. The individual masses 4 are designed as spheres, and the drive wheel 1 has recesses 2 which are formed in the form of semi-spherical half-shells or caps that are congruent in shape to the individual masses 4.

The drive wheel 1 is connected for conjoint rotation to a belt reel 10, on which a seatbelt (not shown) of a seatbelt device can be wound. The belt reel 10 itself is rotatably mounted in a vehicle-mountable frame 11. Furthermore, the tube 5 is provided, in which the mass body chain 3 is arranged and guided, and in the end of which a gas generator 15 is attached, e.g., by crimping. Furthermore, a first tensioner housing half 13 and a second tensioner housing half 12 are provided, which are attached to the outside of the frame 11 and fix the tube 5 with the mass body chain 3 to the frame 11. The first tensioner housing half 13 is directly attached to the frame 11, and the second tensioner housing half 12 is attached to the first tensioner housing half 13 and thus indirectly attached to the frame 11. The first and/or second tensioner housing halves 13 and 12 serve, in addition to fastening the tube 5, to guide the individual masses 4 after they exit the tube 5 and during engagement with the drive wheel 1.

The shaped element 6 according to the prior art and the shaped element 6 according to the further development according to the invention can be seen in FIG. 4 and FIG. 5 in the engagement position in the drive wheel 1. The basic structure of the two shaped elements 6 is identical and comprises a finder portion in the form of a first sub-mass 7 and a second sub-mass 9, wherein the second sub-mass 9 is connected to the first sub-mass 7 via a connecting rib 8.

The first and second sub-masses 7 and 9 are each formed by partially formed individual masses 4, or in other words, by completing the shape of the first sub-mass 7 and the second sub-mass 9, they would have an identical shape to the individual masses 4. Furthermore, the first and second sub-masses 7 and 9 are designed and connected to each other via the connecting rib 8 in such a way that the distance between the centers of the bodies of the imaginary form-completed individual masses 4 of the shaped element 6 has a distance that also corresponds to the distance between the centers of the bodies of the individual masses 4 of the mass body chain 3 engaging in the recesses 2 and successive to each other. The shaped element 6 can therefore be understood as two incompletely formed individual masses 4 connected to each other via a connecting rib 8.

The shaped element 6 of the rotary tensioner further developed according to the invention can be seen in FIG. 2 as an individual part in an oblique view and in FIG. 3 in a view of the end face of the second sub-mass 9. The shaped element 6 has a support surface 14 on the end face of the second sub-mass 9, which support surface is designed in the form of an elongated oval with two parallel edge sides. The support surface 14 is formed in the form of a flattening, which is formed by an imaginary section through the second sub-mass 9 and the shape of which is defined by the shape of the main body of the second sub-mass 9 in the region of the cut face.

The support surface 14 is shaped and arranged such that the shaped element 6 with the support surface 14 rests against the first individual mass 4 of the mass body chain 3, as can be seen in FIG. 5. The support surface 14 is shaped and arranged such that the longer center axis L of the support surface 14 has a straight orientation perpendicular to the rotational axis D of the drive wheel 1, wherein the rotational axis D of the drive wheel 1 extends perpendicularly through the plane of representation in the illustration of FIG. 5.

The support surface 14 has two edge sides oriented parallel to each other and parallel to the center axis L, the distance between which defines a constant width B of the flattening 14 of preferably 3.0 mm, at least in a central portion. The center axis L of the support surface 14 corresponds to a first center axis M1 of the shaped element 6. Furthermore, the support surface 14 is symmetrically oriented with the center axis L and with the first center axis M1 of the shaped element 6, so that the shaped element 6 with the support surface 14 rests symmetrically on both sides of the first center axis M1 against the first individual mass 4. The support surface 14 is further shaped and arranged such that it is arranged asymmetrically to a second center axis M2, which is oriented perpendicular to the first center axis M1. Starting from the center of the shaped element 6 defined by the second center axis M2, the support surface 14 has a smaller extension H1 of approximately 1.5 to 2.0 mm in one direction and a larger extension H2 of 2.5 to 3.2 mm in the other direction. For this purpose, the shaped element 6 in the region of the second sub-mass 9 is designed accordingly in its basic form, so that the different extensions H1 and H2 result solely from the arrangement of the imaginary section through the main body of the second sub-mass 9. The term “section” is of course not to be understood in the sense of cutting off or any other subsequent processing of the shaped element 6, since the shaped element 6 is preferably manufactured as a one-piece injection molded part, e.g., as a plastics injection molded part, which is already produced in its final shape in the injection molding process. The term “section” is only intended to provide a simplified idea of the shape of the support surface 14.

The shaped element 6 is arranged in the tube 5 of the rotary tensioner such that the support surface 14 with the larger extension H2 is directed towards the wall of the tube 5 facing away from the drive wheel 1, while the smaller extension H1 is directed towards the wall of the tube 5 facing the drive wheel 1. Thus, the support surface 14 forms an asymmetrical support for the shaped element 6 perpendicular to the rotational axis D of the drive wheel 1 and a symmetrical support for the shaped element in the direction of the rotational axis.

FIG. 4 shows the rotary tensioner according to the prior art, in which the shaped element 6 does not have a flattened support surface 14, but instead has a curved or semi-spherical surface in the region of the second sub-mass 9. Under unfavorable force conditions, as can be seen in FIG. 4, the shaped element 6 tilts with the second sub-mass 9 in the direction of the drive wheel 1 due to the pressure force exerted by the first individual mass 4, wherein the shaped element 6 rolls with the surface of the second sub-mass 9 on the surface of the first individual mass 4 over a comparatively large rolling angle. This rolling is facilitated by the curved surface of the shaped element 6 in the region of the second sub-mass 9 and the curved surface of the first individual mass 4.

FIG. 5 shows the further developed rotary tensioner according to the invention, in which the shaped element 6 has the flattened support surface 14 in the region of the end face of the surface of the second sub-mass 9. The shaped element 6 is oriented such that the support surface 14 with the longer extension H2 is directed towards the left wall of the tube 5, i.e., toward the wall of the tube 5 facing away from the drive wheel 1. This is advantageous because the shaped element 6 is thereby particularly supported against the tilting direction shown in FIG. 4. Toward the other side, i.e., in the direction of the drive wheel 1, the flat support surface 14 has a shorter extension H1, since the deflection of the shaped element 6 with the first sub-mass 9 to the other side is limited anyway by the wall of the tube 5.

Thus, the flattened support surface 14 has a preferred support direction of the shaped element 6 against a tilting with the second sub-mass 9 in the direction of the drive wheel 1 about a pivot axis directed parallel to the rotational axis D. Due to the symmetrical design of the support surface 14 with respect to the first center axis M1, the shaped element 6 is supported equally, i.e., directionally neutral, in both pivot directions when tilted about a pivot axis perpendicular to the rotational axis D and horizontal in the representation.

In FIG. 6, the shaped element 6 can be seen as an individual part in view of the second sub-mass 9 with the support surface 14 arranged on the lower side in the perspective in the direction of the first center axis M1 of FIG. 3. The flattened support surface 14 has a curvature R which forms the flattened support surface 14 into a groove in this direction. For this purpose, the curvature R is directed opposite to the curvature of the outer surface of the shaped element 6 in the region of the second sub-mass 9, so that the support surface 14 is recessed into the second sub-mass 9. The curvature R has a preferred radius of 20 mm.

The negative curvature R directed into the second sub-mass 9 further reduces the possible rolling angle of the shaped element 6 on the first individual mass 4 in this direction. Provided that the curvature R corresponds to the curvature of the outer shape of the first individual mass 4, this can even result in a planar contact of the shaped element 6 with the first individual mass 4.

1. A rotary tensioner for a seatbelt, comprising
a drive device in the form of a mass body chain that is guided in a tube to which compressed gas is supplied, said mass body chain consisting of a plurality of identical individual masses, in order to drive a belt reel in the winding direction of the seatbelt and comprising
a drive wheel which is rotationally fixed to the belt reel and comprises a plurality of recesses that are arranged on the radial outer face in a uniform manner and are congruently shaped with respect to at least one sub-portion of the outer shape of the individual masses, said drive wheel being rotatable about a rotational axis when the drive device is activated, wherein
the recesses are dimensioned such that a corresponding individual mass of the mass body chain can be received in each of the recesses, wherein
a shaped element is arranged on the mass body chain end facing the drive wheel, wherein
the shaped element has a first sub-mass forming a finder portion in the form of a partially shaped individual mass and a second sub-mass connected to the first sub-mass via a connecting rib in the form of an at least partially shaped individual mass,
wherein
said shaped element has a support surface formed by a flattening, by means of which support surface the shaped element rests against the first individual mass, on the shaped element face facing the first individual mass of the mass body chain in the region of the second sub-mass.

2. The rotary tensioner according to claim 1, wherein
the support surface has a larger extension starting from the center of the shaped element in the direction of the side of the tube facing away from the drive wheel than towards the side of the tube facing the drive wheel.

3. The rotary tensioner according to claim 1, wherein
the support surface is formed by an elongate surface which has a constant width in relation to the longer center axis at least in a central portion in the direction of the width of the drive wheel parallel to the rotational axis of the drive wheel and is arranged symmetrically to a first center axis of the shaped element

4. The rotary tensioner according to claim 1, wherein
the support surface has a straight orientation in a plane perpendicular to the rotational axis of the drive wheel.

5. The rotary tensioner according to claim 1. wherein
the support surface has a curvature, which shapes the support surface into a groove, in an extension oriented in parallel with the rotational axis of the drive wheel.
